(19) United States
(12) Patent Application Publication
(10) Pub. No.: US 2019/0046972 A1
(43) Pub. Date: Feb. 14, 2019

(54) A CARTRIDGE FOR PURIFYING A SAMPLE AND ANALYSIS

(71) Applicant: BIGTEC PRIVATE LIMITED, Bangalore, Karnataka (IN)

(72) Inventors: Manoj Mulakkapurath Narayanan, Bangalore (IN); Chandrasekhar Bhaskaran Nair, Bangalore (IN); Deepak Krishnan Padinhare Purayil, Bangalore (IN); Jayakrishnan Puthiyedathu Chandran, Bangalore (IN); Sathyadeep Viswanathan, Bangalore (IN); Akhil Namboori, Bangalore (IN); Vinaya Ramanabhiraman, Bangalore (IN); Ajith Kumar Manghat, Bangalore (IN); Kishore Krishna Kumar, Bangalore (IN); Justin Kariyancheril Paul, Bangalore (IN); Sivakumar Reddy Jangollu, Bangalore (IN)

(21) Appl. No.: 16/079,072

(22) PCT Filed: Feb. 23, 2017
(86) PCT No.: PCT/IB2017/051030

§ 371 Date: Aug. 22, 2018

(30) Foreign Application Priority Data
Feb. 23, 2016 (IN) 201641006193

(51) Int. Cl. B01L 3/00; G01N 1/34

(52) U.S. Cl. CPC B01L 3/502; G01N 1/34; B01L 2200/0605; B01L 2200/0631; B01L 2300/047; B01L 2200/16; B01L 2400/0487; B01L 2300/0681; B01L 2300/0867; B01L 2300/0877; B01L 2300/0832; B01L 2300/1827; B01L 2400/0457; B01L 2200/10

(57) ABSTRACT

The present disclosure discloses a cartridge for purifying a sample. The cartridge comprising a first chamber having a plurality of compartments for storing a sample and at least one reagent and mix the a sample with the at least one reagent. A second chamber in fluid communication with the first chamber is configured with a matrix member for matrixing at least one analyte. A third chamber in fluid communication with the second chamber is configured with a waste collection chamber for storing waste fluids matrixed in the second chamber. A fourth chamber in fluid communication with the third chamber, includes at least one tube configured to receive and store the at least one analyte from the second chamber, through the third chamber. The cartridge enables purification of multiple samples in a cycle.

### CROSS REFERENCE

This Application claims priority from Indian Patent Application No. 201641006193 filed on Feb. 23, 2016.

### TECHNICAL FIELD

Present disclosure generally relates to the field of Bio-medical engineering. Particularly, the present disclosure relates to a device used for purifying samples and analysis. Embodiments of the present disclosure relates to a cartridge for purifying samples and analysis.

### BACKGROUND OF THE DISCLOSURE

Conventionally, biological and non-biological samples are subjected to various types of analysis for detection of an analyte or a biological entity, which lead to various infectious disease such as Tuberculosis, Malaria and the like. The analysis is carried out either qualitatively or quantitatively, by techniques including, but not limited to, chemical, physical and enzymatic techniques. Several systems have been developed for analysing and testing the biological and non-biological samples.

The system may be in the form of tubes for containing or holding liquid specimens, or may be cards or cartridges to hold the samples. Some systems may place the sample on glass slides, that are suitable for microscopy. These samples are treated with suitable reagents to detect presence or absence of the analyte. The test results are read manually by a technical person or automatically with suitable instruments.

The biological samples are collected from the subject and are subjected to various processing and analysis. Conventional systems undergo multiple steps and are usually time consuming, and laborious. In addition, conventional processing and analysis of samples are carried out in sophisticated laboratories having controlled environment conditions favorable to the samples and reagents. Also, the conventional systems used for processing and analyzing biological samples are bulky, expensive and complex, and require uninterrupted power supply for carrying out the process.

To mitigate some of the problems stated above, automated cartridge type systems have been developed and employed, for processing and analysing the samples. The cartridge type systems employ robotic assemblies for controlling the processes involved in analysis of the biological samples. These robots are generally programmed with specific co-ordinates for processing and analysing the sample. Thus, any variation in the robotic co-ordinates while transporting the system will affect characteristics of the sample.

The present disclosure is directed to overcome one or more limitations stated above.

The information disclosed in this background of the disclosure section is only for enhancement of understanding of the general background of the invention and should not be taken as an acknowledgement or any form of suggestion that this information forms the prior art already known to a person skilled in the art

### SUMMARY OF THE DISCLOSURE

One or more shortcomings of conventional assemblies are overcome and additional advantages are provided through the provision of an assembly as claimed in the present disclosure. Additional features and advantages are realized through the techniques of the present disclosure. Other embodiments and aspects of the disclosure are described in detail herein and are considered a part of the claimed disclosure.

In a non-limiting embodiment of the present disclosure, a cartridge for purifying a sample is disclosed. The cartridge comprising a first chamber having a plurality of compartments for storing a sample and at least one reagent, wherein the first chamber is configured to mix the a sample with the at least one reagent. A second chamber in fluid communication with the first chamber is configured with a matrix member, wherein the matrix member receives the mixture of the a sample and the at least one reagent, for binding at least one analyte. A third chamber in fluid communication with the second chamber is configured with a waste collection chamber for storing waste fluids matrixed in the second chamber. A fourth chamber in fluid communication with the third chamber, includes at least one tube configured to receive and store the at least one analyte from the second chamber, through the third chamber.

In an embodiment, the plurality of compartments includes a sample chamber for processing the sample and at least one reactant chamber for storing the at least one reactant.

In an embodiment, the first chamber comprises a reaction chamber in fluid communication with the plurality of compartments for mixing the sample with the at least one reagent.

In an embodiment, the first chamber includes a heating element for heating the a sample and the at least one reagent.

In an embodiment, the matrix member is at least one of cotton matrix and cellulose matrix.

In an embodiment, the sample is at least one of biological samples and non-biological samples.

In an embodiment, the third chamber includes a conduit in fluid communication with the second chamber and the at least one tube for routing the at least one analyte.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the description. The disclosure itself, however, as well as a preferred mode of use, further objectives and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1a illustrates exploded view of a cartridge for purifying a sample and its analysis, in accordance with an embodiment of the present disclosure.

FIG. 1b illustrates another embodiment of the cartridge of FIG. 1a.

FIG. 1c illustrates sectional view of assembly of the cartridge of FIG. 1a, in accordance with an embodiment of the present disclosure.

FIG. 2a illustrates exploded view of a first chamber of the cartridge, in accordance with an embodiment of the present disclosure.

FIG. 2b illustrates assembled view of the first chamber of the cartridge, in accordance with an embodiment of the present disclosure.

FIG. 2c illustrates top view of the first chamber of the cartridge, in accordance with an embodiment of the present disclosure.

FIG. 3a illustrates exploded view of a second chamber of the cartridge, in accordance with an embodiment of the present disclosure.

FIG. 3b illustrates assembled view of the second chamber of the cartridge, in accordance with an embodiment of the present disclosure.

FIG. 4a illustrates exploded view of a third chamber of the cartridge, in accordance with an embodiment of the present disclosure.

FIG. 4b illustrates sectional view of the third chamber of the cartridge, in accordance with an embodiment of the present disclosure.

FIG. 5a illustrates exploded view of a fourth chamber of the cartridge, in accordance with an embodiment of the present disclosure.

FIG. 5b illustrates assembled view of the fourth chamber of the cartridge, in accordance with an embodiment of the present disclosure.

FIG. 6 illustrates process flow chart for purifying the sample by the cartridge, in accordance with an embodiment of the present disclosure.

The figures depict embodiments of the disclosure for purposes of illustration only. One skilled in the art will readily recognize from the following description that alternative embodiments of the assemblies, structures and methods illustrated herein may be employed without departing from the principles of the disclosure described herein.

### DETAILED DESCRIPTION

While the embodiments in the disclosure are subject to various modifications and alternative forms, specific embodiment thereof has been shown by way of example in the figures and will be described below. It should be understood, however, that it is not intended to limit the disclosure to the particular forms disclosed, but on the contrary, the disclosure is to cover all modifications, equivalents, and alternative falling within the scope of the disclosure.

It is to be noted that a person skilled in the art would be motivated from the present disclosure of a cartridge for purifying a sample and its analysis, which may vary based on configuration of the cartridge. However, such modifications should be construed within the scope of the disclosure. Accordingly, the drawings show only those specific details that are pertinent to understand the embodiments of the present disclosure, so as not to obscure the disclosure with details that will be readily apparent to those of ordinary skill in the art having benefit of the description herein.

The terms “comprises”, “comprising”, “includes” or any other variations thereof used in the disclosure, are intended to cover a non-exclusive inclusion, such that an assembly that comprises a list of components does not include only those components but may include other components not expressly listed or inherent to such system, or assembly, or device. In other words, one or more elements in an assembly proceeded by “comprises . . . a” does not, without more constraints, preclude the existence of other elements or additional elements in the system or device.

Embodiments of the present disclosure relates to a cartridge for purifying a sample and analysis. The cartridge is configured to also analyse multiple analytes from same sample. In an embodiment, the cartridge is configured to receive at least one sample for purification and analysis. The cartridge comprising a first chamber having a plurality of compartments for storing the sample and the at least one reagent. The first chamber is configured to mix the sample with the at least one reagent, thereby initiating process of purification. A second chamber in fluid communication with the first chamber is configured with a matrix member. The matrix member receives the mixture of the sample and the at least one reagent, for binding at least one analyte. A third chamber in fluid communication with the second chamber is configured with a waste collection chamber for storing waste fluids generated in the process. A fourth chamber in fluid communication with the third chamber, includes at least one tube configured to receive and analyse the at least one analyte from the second chamber, through the third chamber.

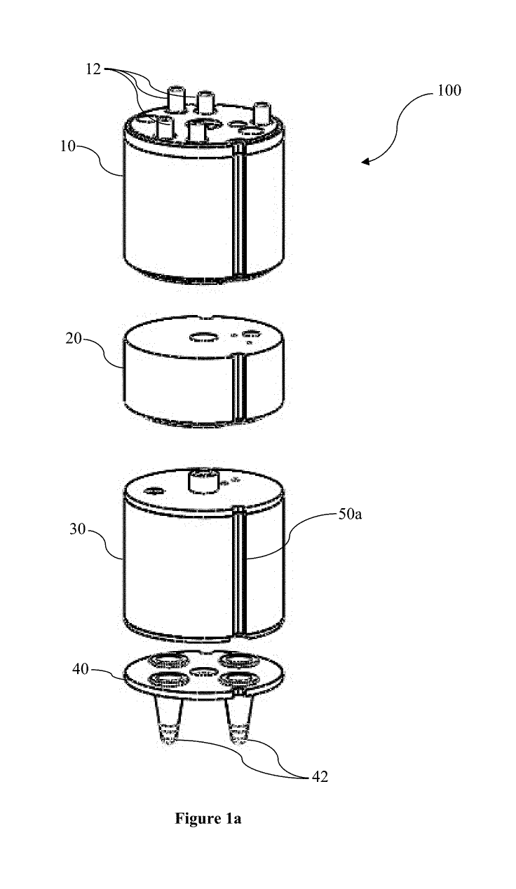

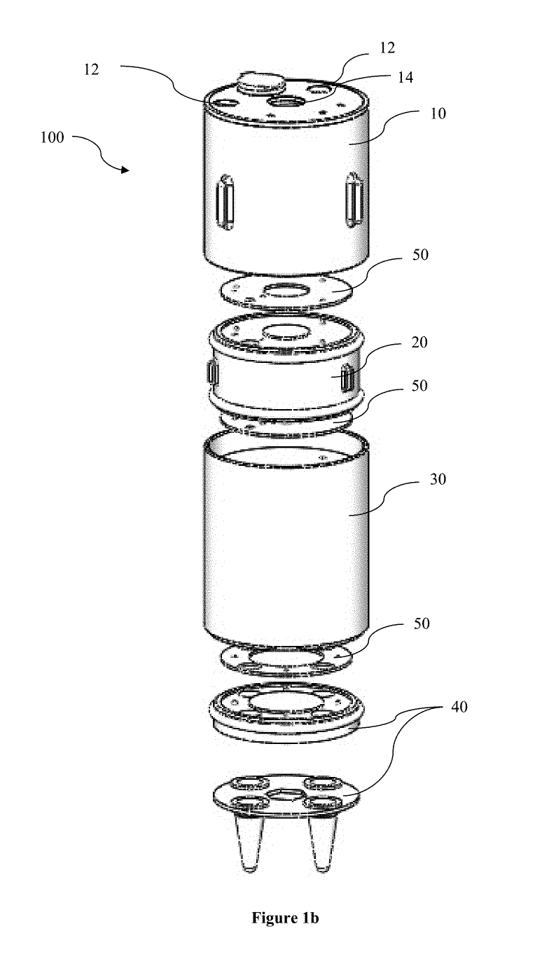

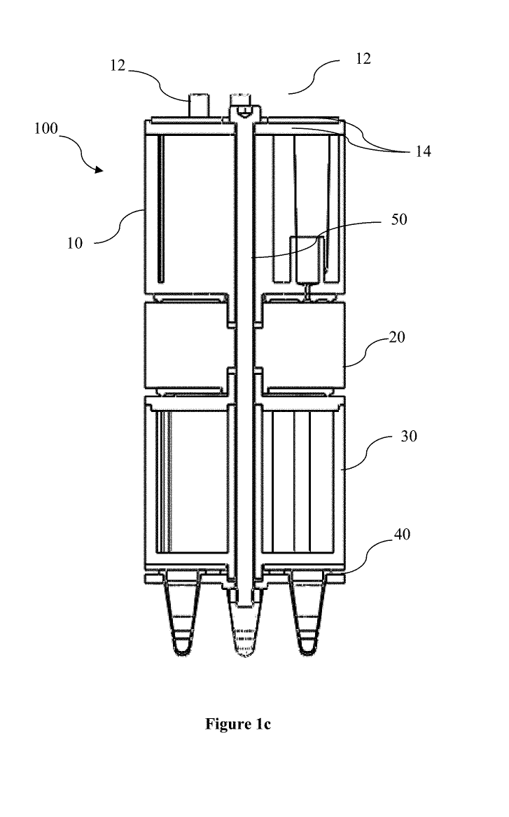

The following paragraphs describe the present disclosure with reference to FIGS. 1 to 6. In the Figures, the same element or elements which have similar functions are indicated by the same reference signs.

FIG. 1a-1c are exemplary embodiments of the present disclosure which illustrate exploded view, assembled view and sectional view of the cartridge (100) for purifying a sample. The cartridge (100) comprises a plurality of chambers i.e. a first chamber (10), a second chamber (20), a third chamber (30) and a fourth chamber (40) in fluid communication with one another. The plurality of chambers (10, 20, 30, and 40) are connected to one another by a connecting member (50), provisioned at the contact points between each of the plurality of chambers (10, 20, 30 and 40) [shown in FIG. 1b].

In an embodiment, the connecting member (50) may be a plate like structure, having locking points, portions or protrusions to lock each of the plurality of chambers (10, 20, 30 and 40) [shown in FIG. 1b]. In another embodiment, the connecting member (50) may be a threaded screw, configured to fasten each of the plurality of chambers (10, 20, 30 and 40) [shown in FIG. 1c]. In another embodiment, a slot (50a) is provided on each of the plurality of chambers (10, 20, 30 and 40) to enable rotary motion, thereby facilitating threaded connection of each of the plurality of chambers (10, 20, 30 and 40). The connecting members (50) ensure leak proof connectivity between the chambers so that leakage of fluids between the plurality of chambers (10, 20, 30 and 40) is prevented, during operation. In an embodiment, the material of the connecting member (50) is selected from a group of polymeric and elastomeric materials, such as rubber, silicone, grease, silicone oil, fluorocarbons and the like. The connecting member (50) ensures anti-frictional rotational movement between each of the plurality of chambers (10, 20, 30 and 40).

In an embodiment of the present disclosure, material of the plurality of chambers (10, 20, 30 and 40) may be selected from a group of polymers and plastics, such as, but not limited to, polypropylene, polycarbonate, polyesters, polystyrenes, styrenes, acrylics, rubber, silicone and the like. The material selection is based on design feasibility and requirement.

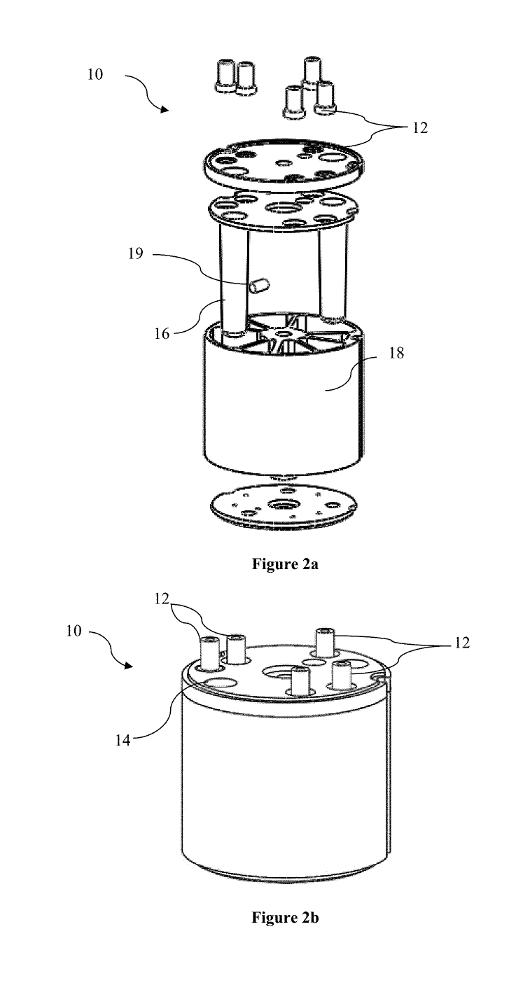

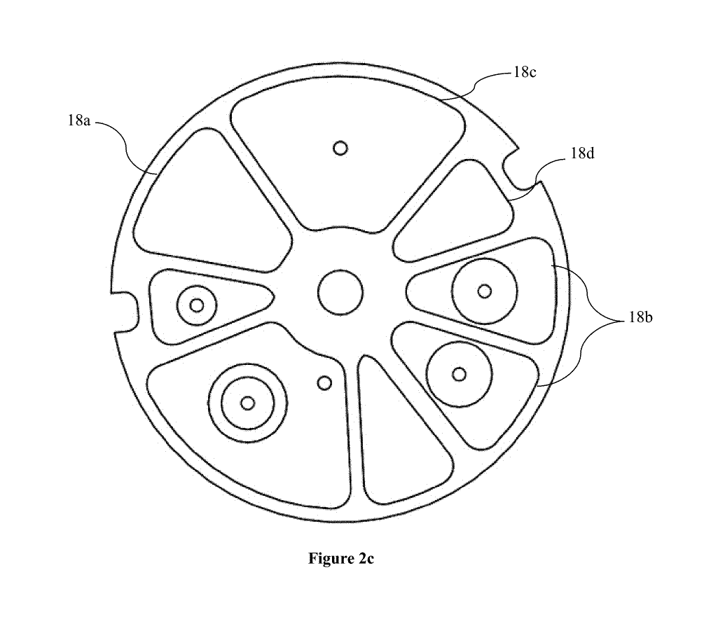

FIGS. 2a-2c are exemplary embodiments of the present disclosure which illustrate exploded view, assembled view and top view of the first chamber (10) of the cartridge (100) respectively. The first chamber (10) has inlet ports (12), for receiving the sample and the at least one reagent. The first chamber (10) has a plurality of compartments (18) for storing sample, and at least one first reagent received from the inlet ports (12). The plurality of compartments (18) may be classified into sample chamber (18a) for storing the sample and a reagent chamber (18b) for storing at least one reagent [shown in FIG. 2c]. A reaction chamber (18c) is provisioned in the first chamber (10), which is in fluid communication with the sample chamber (18a) and the reagent chamber (18b). The reaction chamber (18c) receives the sample and the at least one reagent from the respective chambers (18a and 18b), for chemical reactions to take place. At least one heating element (16) is provisioned in the first chamber (10), for maintaining predetermined temperature in the reaction chamber (18c), so that temperature of the mixture is maintained at a predetermined temperature range. The temperature enables chemical reaction between the sample and the at least one reagent at an optimum rate. In an embodiment of the present disclosure, the heating element (16) is a conductive, resistive or inductive type resistance coil extending inside the reaction chamber (18c). In an embodiment, the heating element (16) is tube like structure, configurable in a heater sleeve [not shown] in the first chamber (10). In an embodiment, the heating element (16) is provided in the sample chamber (18a) and the reaction chamber (18c). The reaction chamber (18c) includes a mixer (19) configured to mix the sample and the at least one reagent received by the reaction chamber (18c). In an embodiment, the mixer (19) is selected from at least one of a magnetic stirrer, mechanical stirrer and the like.

Referring to FIG. 2c, at least one isolation chamber (18d) is provided in between the sample chamber (18a) and the reagent chamber (18b), as insulation for heat transfer. This configuration enables the sample and the at least one reagent entering the reaction chamber (18c) to be in optimum thermal conditions. An outlet port (14) is provided in the first chamber (10), for discharging mixture of the sample and the at least one reagent into the second chamber (20).

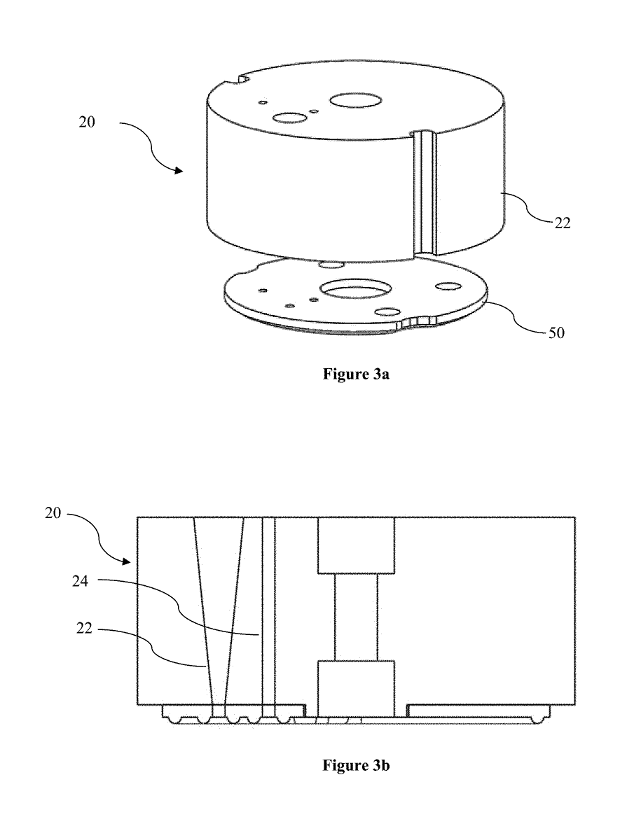

FIGS. 3a and 3b are exemplary embodiments of the present disclosure which illustrate exploded view and sectional view of the second chamber (20) of the cartridge (100). The second chamber (20) is disposed in fluid communication with the first chamber (10), and is configured to receive mixture of the sample and the at least one reagent from the first chamber (10). A receiving port or an inlet port (not shown) of the second chamber (20) is fluidly connected to outlet port (14) of the first chamber (10).

Referring to FIG. 3b, the second chamber (20) comprises a matrix member (22) configured to bind a predetermined constituent of the sample to obtain at least one analyte [which may include nucleic acids, proteins and cells], from the mixture of the sample and the at least one reagent. In an embodiment, the matrix member (22) is configured in a tapered manner, to enable feasibility of flow of waste fluids from the matrix member (22) after separation. The matrixed at least one analyte may be bound to the matrix member (22). The matrixed at least one analyte flows to the third chamber (30) via a conduit (24). In an embodiment, the matrix member (22) may be a cotton or cellulose based matrix. In another embodiment, the matrix member (22) may be any other material which serves the requirement of binding of the at least one analyte from the mixture of the sample and the at least one reagent. In an embodiment, a guiding hole (26) is provided in the second chamber (20), for receiving the connecting member (50).

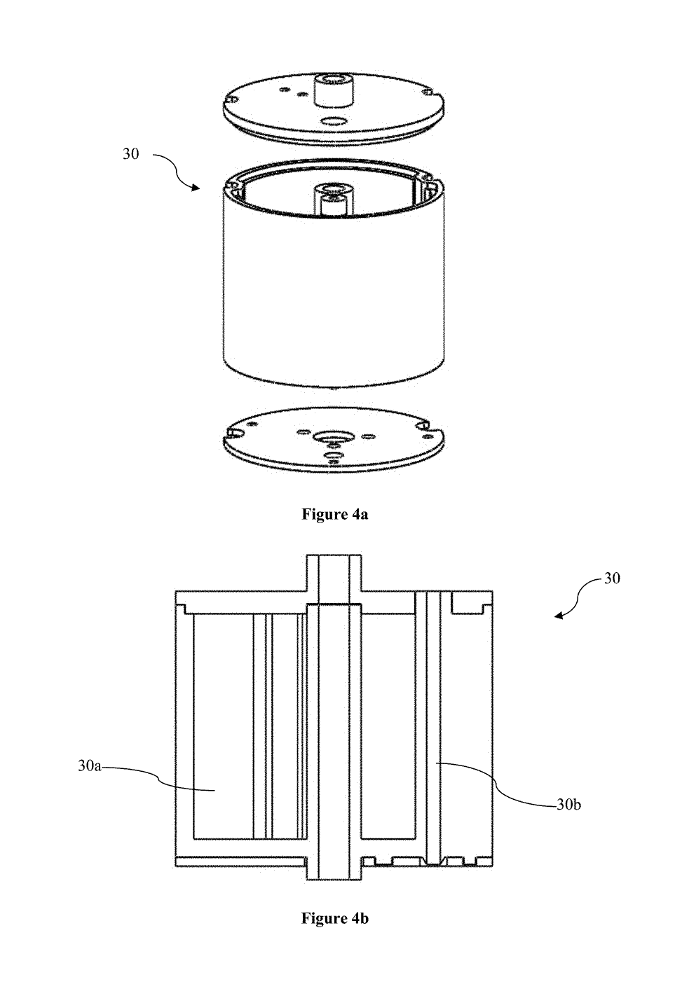

FIGS. 4a and 4b are an exemplary embodiment of the present disclosure which illustrates exploded view and sectional view of the third chamber (30) of the cartridge (100). The third chamber (30) is in fluid communication with the second chamber (20). The third chamber (30) is a distribution chamber which distributes fluid received from the second chamber (20). The third chamber (30) thus, distributes the at least one analyte, and allows flow of the at least one analyte into the fourth chamber (40). The waste fluids are stored in the waste collection chamber (30a) of the third chamber (30). The waste fluids, therefore, are not exposed to environment and are safely disposed from the waste collection chamber (30a).

The third chamber (30) is provisioned with a flow path (30b), which is in fluid communication with the conduit (24) to allow measured flow of at least one analyte into the fourth chamber (40) from the second chamber (20), through the third chamber (30). At least one metering unit (not shown) may be provisioned to allow flow of metered quantity of at least one analyte into the fourth chamber (40). In an embodiment, the third chamber (30) may be interfaced with a control unit (not shown) for metered flow of at least one analyte into the fourth chamber (40).

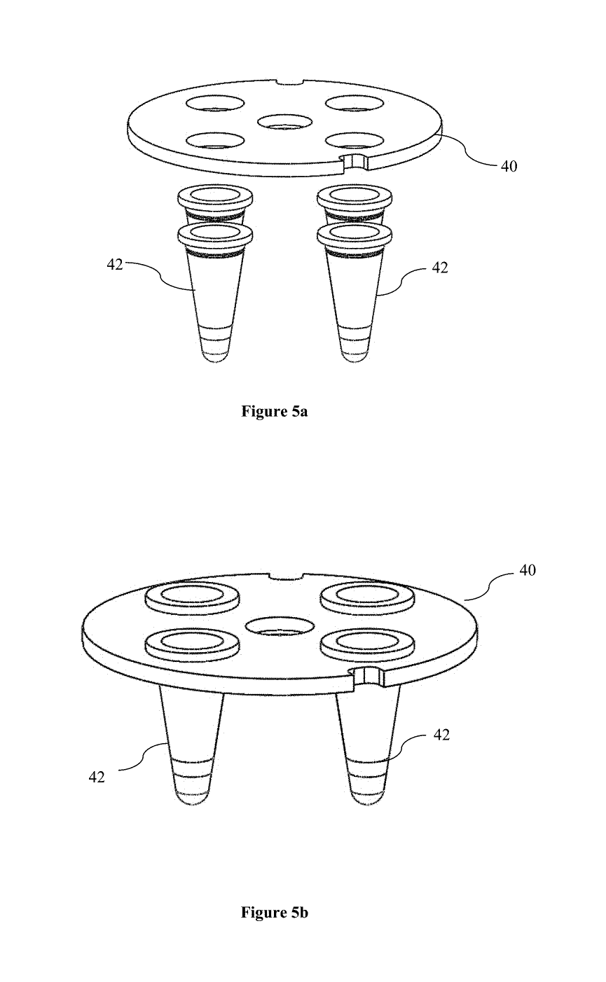

FIGS. 5a and 5b are exemplary embodiments of the present disclosure which illustrate exploded view and assembled view of the fourth chamber (40) of the cartridge (100). The fourth chamber (40) is in fluid communication with the third chamber (30). The fourth chamber (40) includes at least one tube (42), in fluid communication with the flow path (30b) for receiving at least one analyte and analysing it. The at least one tube (42) is provided such that, assembly of the cartridge (100) in an analyte detection device, may enable the analyte detection device to analyse the at least one analyte in the at least one tube (42).

In an embodiment of the disclosure, the flow of samples in the cartridge (100) may be achieved by gravity or air pressure from running device. In an alternative embodiment, a flow assistance means such as pumps may be installed to aid fluid flow in the cartridge (100).

In an embodiment, the plurality of compartments (18) may store pre-filled liquids and solid reagents. In another embodiment, the plurality of compartments (18) can receive at least one reagent added by a user, before use.

In an embodiment of the disclosure, the plurality of chambers (10, 20, 30, and 40) are connected end to end serially such that they are stacked one above the other in a predetermined order.

In an embodiment, the chambers (10, 20, 30, and 40) may be cylindrical in shape. In another embodiment, the cross section of the chambers (10, 20, 30, and 40), may be selected from any of geometric shape such as square, rectangle and the like, based on feasibility and requirement.

In an embodiment, each of the chambers (10, 20, 30 and 40) are configured with predetermined volumes, based on feasibility and requirement. In an embodiment, the sample chamber (18a) is configured to receive 3.0 ml. In an embodiment, the at least one reagent chamber (18b) is configured with a volume of 1.45 ml. In an embodiment, the matrix member (22) in the second chamber (20) is filled with 20 mg of matrix material. In an embodiment, the waste collection chamber (30a) is configured with a volume of 17.3 ml. In an embodiment, the each of the at least on tube (42) is configured with a volume ranging from 8 μl to 15 μl.

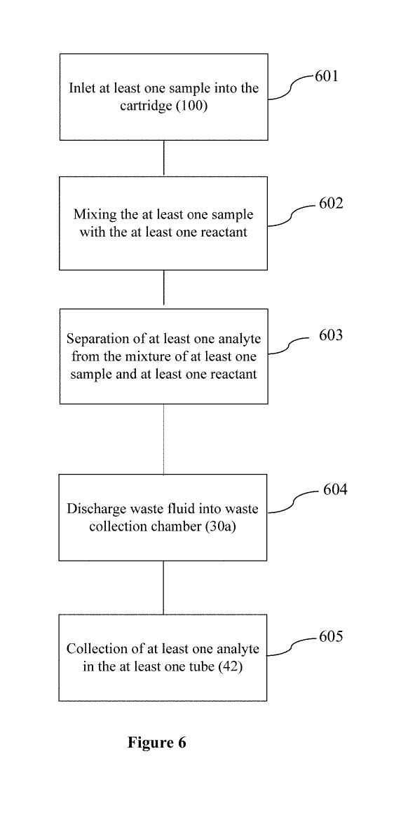

FIG. 6 illustrates a process flow chart for purification of the sample by the cartridge (100).

In step 601, the cartridge (100) is inlet with the sample via the inlet ports (12) and is stored in the sample collection chamber (18a). In an embodiment, each sample is inlet into the separate sample collection chamber (18a) via corresponding inlet ports (12).

In step 602, the sample and the at least one reactant are inlet into the reaction chamber (18c), for mixing and chemical reactions involving lysis and denaturation. In this condition, the heating element (16) is operated to maintain temperature in the reaction chamber (18c), for chemical reaction. In an embodiment, the at least one reactant passed into the reaction chamber (18c) may be wash solutions such as buffer solutions, for washing out impurities from the sample.

In step 603, the washed or mixed sample and the at least one reagent is discharged to the second chamber (20). The matrix member (22), receives the mixture and separates the at least one analyte and the waste fluids remaining in the mixture. The separated at least one analyte, flows through the conduit (24) to the third chamber (30).

In step 604, the waste fluids are discharged to the waste collection chamber (30a) in the third chamber (30). Thus, prevent contact of waste fluids with the environment. The flow path (30b) connects the outlet of the conduit (24) and the at least one tube (42) in the fourth chamber (40), to facilitate flow of at least one analyte into the at least one tube (42). The metering unit provisioned in the third chamber (30), measures the amount of the at least one analyte flowing into the at least one tube (42). The waste collection chamber (30a) may have an absorbent to absorb the waste fluids.

In step 605, the at least one analyte collected in the at least one tube (42) is received by a sample analysing device, for Polymerase Chain Reaction [PCR] analysis of the sample. In an embodiment, each of the at least one tube (42) is configured with pre-stored dry-stabilized reagents required for PCR analysis. In an embodiment, each of the at least one tube (42), is configured for one to four PCR analysis of the sample.

In an embodiment, for an input volume of 250 μl of blood sample inlet into the cartridge (100) and an analyte or elute volume of 100 μl. The following table 1, are the PCR results for detecting Salmonella sp. The PCR was carried out for the analyte (target) and an Internal Positice Control (IC). IC was co-processed with the sample in matrix chamber to validate the process of purification. The cycling conditions for the process is mentioned in below table 2.

TABLE 2
Cycling condition

95 for 1 minute
95 for 10 seconds
60 c for 34 seconds
45 cycles

From the above table 1, it is evident that the detected concentration of Salmonella nucleic acid by the cartridge is comparable to a commercial standard (Qiagen).

In an embodiment, for an input volume of 0.5 ml sample, 2.5 ml of lysis buffer, and elute volume of 100 μl. The following table 3, are the PCR results for detecting Mycobacterium tuberculosis (MTB). The cycling conditions for the process is mentioned in below table 4.

Cycling condition

95 for 1 minute
95 for 10 seconds
60 c for 34 seconds
45 cycles

From the above table 2, it is evident that the concentration of analyte DNA (MTB, target) is comparable to control extraction performed using an approved kit.

### Advantages

In an embodiment, the present disclosure provides a cartridge, which can purify one sample and analyse for multiple analytes at a time

The disclosure provides an automated, hands-free detection of multiple analytes.

In an embodiment, the present disclosure provides a cartridge, which contains waste fluids, thereby preventing exposure of waste fluids to the environment. Thus, rendering the usage and disposal of the cartridge bio-safe.

In an embodiment, the present disclosure provides a cartridge, which is integrated and self contained of all reagents required for the purification and detection of analytes.

In an embodiment, the present disclosure provides a cartridge, which stores all required reagents at room temperature stabilized form, for easy transport, storage and usage at resource limited settings.

In an embodiment, the present disclosure provides a cartridge, which can be used in a portable device at point of care.

### Equivalents

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure.

It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

REFERRAL NUMERALS

| Reference Number | Description |
|---|---|
| 100 | Cartridge |
| 10 | First chamber |
| 12 | Inlet ports |
| 14 | Outlet port |
| 16 | Heating element |
| 18 | Plurality of compartments |
| 18a | Sample chamber |
| 18b | At least one reactant chamber |
| 18c | Reaction chamber |
| 18d | Isolation chamber |
| 19 | Mixer |
| 20 | Second chamber |
| 22 | Matrix member |
| 24 | Conduit |
| 30 | Third chamber |
| 30a | Waste collection chamber |
| 30b | Flow path |
| 40 | Fourth chamber |
| 42 | At least one tube |
| 50 | Connecting elements |
| 50a | Slot |
| 601-605 | Process steps |

We claim:

1. A cartridge (100) for purifying a sample and detection of multiple analytes, the cartridge (100) comprising:
a first chamber (10) having a plurality of compartments (18) for loading the sample and at least one reagent, wherein the first chamber (10) is configured to mix the sample with the at least one reagent;
a second chamber (20) in fluid communication with the first chamber (10) is configured with a matrix member (22), wherein the matrix member (22) receives the mixture of the sample and the at least one reagent, for binding at least one analyte from the mixture of the sample and the at least one reagent;
a third chamber (30) in fluid communication with the second chamber (20), configured with a waste collection chamber (30a) for storing waste fluids discharged from the second chamber (20); and
a fourth chamber (40) in fluid communication with the third chamber (30), includes at least one tube (42) configured to receive the at least one analyte from the second chamber (20), through the third chamber (30).

2. The cartridge (100) as claimed in claim 1, wherein the plurality of compartments (18) includes a sample chamber (18a) for loading the sample and at least one reactant chamber (18b) for loading the at least one reactant.

3. The cartridge (100) as claimed in claim 1, wherein the first chamber (10) comprises a reaction chamber (18c) in fluid communication with the plurality of compartments (18) for mixing the sample with the at least one reagent.

4. The cartridge (100) as claimed in claim 1, wherein the first chamber (10) includes a heating element (16) for heating the sample and the at least one reagent.

5. The cartridge (100) as claimed in claim 1, wherein the matrix member (22) is a cotton matrix.

6. The cartridge (100) as claimed in claim 1, wherein the sample is at least one of biological samples and non-biological samples.

7. The cartridge (100) as claimed in claim 1, wherein the third chamber (30) includes a flow path (30b) in fluid communication with the second chamber (20) and the at least one tube (42) for routing the at least one analyte.

8. A device for purifying biological samples comprising a cartridge (100) as claimed in claim 1.
